(19) United States
(12) Patent Application Publication
(10) Pub. No.: US 2026/0065291 A1
(43) Pub. Date: Mar. 5, 2026

(54) SYSTEM AND METHOD TO ADDRESS COMPLIANCE COVERAGE FOR TRADE SURVEILLANCE

(71) Applicant: NICE LTD., Ra'anana (IL)

(72) Inventors: Nikhil RUDRAKAR, Pune (IN); Girish DESHPANDE, Pune (IN); Deep SHIKHA, Pune (IN)

(21) Appl. No.: 18/823,910

(22) Filed: Sep. 4, 2024

(51) Int. Cl. G06Q 30/018

(52) U.S. Cl. CPC G06Q 30/018

(57) ABSTRACT

Systems adapted to provide trade surveillance and compliance coverage and methods, and non-transitory computer readable media, include providing to a machine learning model, trained to output an indication of whether suspicious activity has occurred, input data comprising market data for a unique financial instrument; generating an output based on the input data, using the trained machine learning model, the output comprising a shape detection metric that identifies a suspicious activity; identifying a set of analytical models that correspond with the suspicious activity identified by the shape detection metric, wherein the set of analytical models is enabled once identified; analyzing the input data using the identified set of analytical models to confirm the suspicious activity identified by the shape detection metric; and triggering, based on confirmation of the suspicious activity identified by the shape detection metric, a suspicious activity alert.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of trade surveillance and compliance coverage, and more specifically relates to methods and systems to perform trade surveillance and provide compliance coverage to customers with limited compliance audit capability.

### BACKGROUND

The subject matter discussed in this background section should not be assumed to be prior art merely as a result of its mention herein. Similarly, a problem mentioned in this background section or associated with the subject matter of the background section should not be assumed to have been previously recognized (or be conventional or well-known) in the prior art. The subject matter in this background section merely represents different approaches, which in and of themselves may also be inventions.

Numerous industries require trade compliance solutions to ensure proper compliance with financial laws and regulations regarding market activities. In some cases, a company may opt to use a trade compliance system to monitor its financial transactions, to flag potentially fraudulent market activity, and to correct and/or report any detected fraudulent behavior. A trade compliance system may include various algorithms, analytical models, and other forms of data processing tools to provide trade surveillance and ensure legal compliance.

Due to budgetary and operational constraints, a company using a trade compliance system to analyze and monitor its market activities may only enable a portion of available analytical models in the system, leaving some analytical models disabled for various reasons. Because this partial enablement causes limited trade compliance audit capability, customers may be subject to fines or other penalties relating to trade compliance issues that were not caught by the enabled models, which may have been flagged by one or more disabled models in the trade compliance solution if they had been enabled. Further, even if a customer has enabled all analytical models available in the trade compliance system, processing market activity data through so many algorithms may require resources and capabilities beyond most customer service level agreements (SLAs).

There exist methods which allow for a disabled analytical model to later be enabled (and potentially used to analyze historical data) if requested by a customer, however, those methods require a customer independently becoming aware of fraudulent or suspicious activity in its market data. Depending on the type and number of analytical models a customer currently has enabled, they may be unaware of suspicious activity in their market data, and may have a false sense of security. Alternatively, a customer may be aware of their limited audit capability, however they may not know which disabled analytical models to subsequently enable, and may opt to maintain their limited audit capability in the face of budget constraints.

Accordingly, there is a need for a system that can identify suspicious market activity, as well as corresponding disabled analytical models, in order to perform trade surveillance and provide compliance coverage to customers with limited trade compliance audit capability.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified data flow in a system according to various aspects of the present disclosure.

FIG. 2 is a flowchart of a method of trade surveillance and compliance coverage according to embodiments of the present disclosure.

FIGS. 3A-3B are exemplary market data graphs generated by the system according to embodiments of the present disclosure. FIG. 3C is an exemplary illustration of a transaction identified on an exemplary market data graph according to embodiments of the present disclosure.

FIG. 4 illustrates an exemplary user interface that allows a user to receive information from the system according to embodiments of the present disclosure.

FIG. 5 is a simplified data flow for training a shape detection model in a system according to embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein relate to trade surveillance and compliance coverage. In various embodiments, market activities using financial instruments are monitored by generating a trained machine learning model by training, using training data comprising market data for one or more financial instruments, associated flagged suspicious activity, associated user input, or a combination thereof, a machine learning model to output, based on the market data, an indication of whether suspicious activity has occurred, wherein training the machine learning model includes modifying one or more weights of one or more nodes of an artificial neural network. Input data comprising market data for a unique financial instrument is provided to the trained machine learning model, wherein the input data is a market data graph comprising market data for the unique financial instrument for a predetermined time period. An output is generated based on the input data, using the trained machine learning model. The output includes a shape detection metric that identifies a suspicious activity based on the shape of preselected market data in graph form. A set of analytical models that correspond with the suspicious activity identified by the shape detection metric is identified, wherein the set of analytical models is enabled once identified. The input data is analyzed using the identified set of analytical models to confirm the suspicious activity identified by the shape detection metric. A suspicious activity alert is triggered based on confirmation of the suspicious activity identified by the shape detection metric.

In various embodiments, market data for one or more financial instruments comprises data from financial transactions involving the one or more financial instruments, stock exchanges, financial news providers, historical databases, or a combination thereof.

In some embodiments, generating an output based on the input data using the trained machine learning model, the output comprising a shape detection metric that identifies a suspicious activity includes identifying a set of points on the market data graph, including lower and upper extrema. Based on the set of points on the market data graph, a set of shapes is identified corresponding with known suspicious market activities, and based on the identified set of shapes corresponding with known suspicious market activities, a shape detection metric that identifies a suspicious activity is generated.

In certain embodiments, triggering the suspicious activity alert comprises generating an alert comprising the identified suspicious activity, and sending the alert to a user of the system. In some embodiments, user input associated with the suspicious activity alert is received via a user interface.

In several embodiments, the input data provided to the trained machine learning model has been optimized to capture suspicious activity. The optimized input data is generated using a previously identified shape detection metric, a previous suspicious activity alert, or a combination thereof, of the unique financial instrument, and the optimized input data is an optimized market data graph comprising market data for the unique financial instrument for a specified time period.

In one or more embodiments, the system may include at least one processor and a non-transitory computer readable storage medium containing instructions which, when executed on the one or more data processors, cause the one or more data processors to perform any of the methods disclosed herein is provided. In one or more embodiments, a computer-program product tangibly embodied in a non-transitory machine-readable storage medium, including instructions configured to cause one or more data processors to perform any of the methods disclosed herein, is provided.

The embodiments described herein improve one or more technical fields, such as for example the technical field of trade surveillance and compliance coverage. For example, the embodiments described herein improve the technical field of trade surveillance and compliance coverage by identifying shapes corresponding with suspicious or fraudulent financial activity in the market data of a unique financial instrument, and automatically enabling analytical models that were previously disabled, in order to confirm the suspicious or fraudulent financial activity identified in the market data. This example improvement is due to the described embodiments providing a technical solution (e.g., a shape detection model that has been trained to identify shapes corresponding with suspicious financial activity using historical market data) to a technical problem (e.g., failing to detect fraudulent financial activity in the market data of a unique financial instrument, leading to reduced trade compliance audit capabilities).

In some embodiments, the embodiments described herein include an unconventional combination of steps that results in improvements to the technical field of trade surveillance and compliance coverage. For example, the combination of steps associated with training the machine learning model using historical market data is associated with predictions and learning of shapes corresponding to suspicious or fraudulent financial activity that is more accurate, and in some cases, may be associated with detection of novel shapes corresponding to suspicious or fraudulent financial activities that is currently unknown in the technical field.

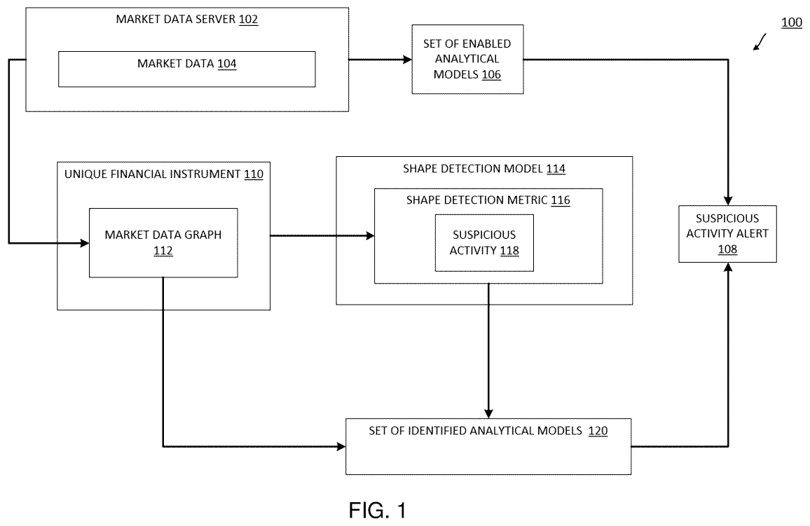

FIG. 1 illustrates data flow in an example trade surveillance and compliance coverage system 100 (also referred to herein as system 100), according to some embodiments of the present disclosure. As shown, system 100 may include or implement a plurality of devices, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX® OS, a LINUX® OS, or another suitable device and/or server-based OS. It will be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, machine learning (ML), neural network (NN), and other artificial intelligence (AI) architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities. To be clear, the system 100 disclosed herein may be operated by a client or at a client site, or may be operated partly or wholly remotely from a client site where the inputs described herein are received partly or entirely from a remote client site.

As various financial transactions (e.g., trading of financial instruments) are conducted as part of a customer's market activities, system 100 may receive market data 104 for each financial transaction, and may store market data 104 in market data server 102. In one or more embodiments, market data 104 for a financial transaction may include data relating to the transaction itself (e.g., the unique financial instruments that were traded), data from stock exchanges, data from financial news providers, data from historical databases, or a combination thereof.

In one or more embodiments, a customer may have a set of analytical models enabled (through purchasing or subscription-based access) (e.g., set of enabled analytical models 106), in order to monitor its market activities relating to its financial transactions. Enabled analytical models may be used to analyze market data received for a customer's financial transactions and/or market activities, and to trigger an alert to a customer using system 100 if any suspicious activities have occurred. For example, market data 104 may be analyzed by set of enabled analytical models 106, such that a customer-user receives a suspicious activity alert 108 if any suspicious activities are detected.

In various embodiments, a customer may not have enabled all analytical models available in system 100. In such embodiments, market data 104 is analyzed by system 100 to identify unique financial instruments (e.g., unique financial instrument 110) corresponding to the transaction data included in market data 104. A market data graph is generated by system 100 for each uniquely identified financial instrument for a predetermined time period, by using market data for the financial instrument fetched from market data server 102. As a non-limiting example, market data graph 112 is generated for unique financial instrument 110, using market data 104 for unique financial instrument 110 fetched from market data server 102. In some embodiments, the market data fetched for a unique financial instrument may be intraday market data. Market data graph 112 may then sent as input to shape detection model 114. It is also possible for the market data graph 112 to be generated for two or more comparable financial instruments for the same time period using market data 104 fetched from market data server 102, which can permit an additional analysis to help identify unusual financial activity according to the remainder of the disclosure herein.

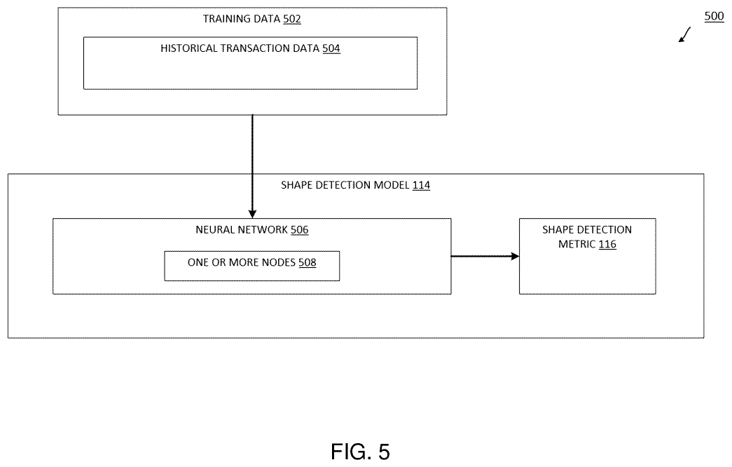

In some embodiments, shape detection model 114 may be a trained regression machine learning model. In some embodiments, shape detection model 114 may include a neural network, comprising one or more nodes. The training of shape detection model 114 is discussed further with respect to FIG. 5 below.

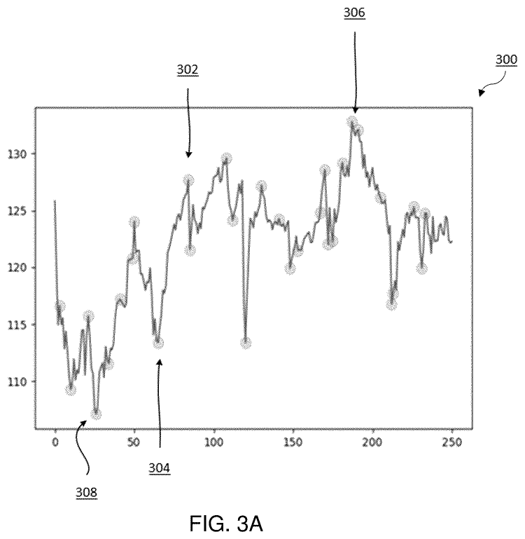

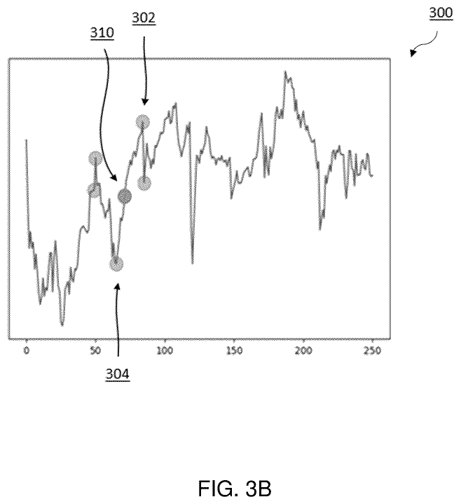

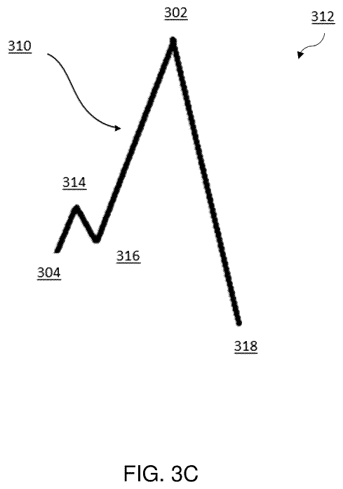

In various embodiments, shape detection model 114 identifies, on market data graph 112, an output including a shape detection metric (e.g., shape detection metric 116) that identifies a suspicious activity (e.g., suspicious activity 118). Shape detection model 114 may identify a set of points on market data graph 112, and identify, based on the set of points, a set of shapes corresponding with known suspicious market activities. In order to identify the set of points on market data graph 112, shape detection model 114 may calculate the rolling window mean with index as close price, and calculate local maxima and minima within various time windows, as well as global lower and upper extrema, of the predetermined time used to generate market data graph 112. In some embodiments, the time windows may be in units of hours, minutes, etc. Shape detection model 114 will then identify a set of shapes formed by connecting various points of the set of points, in order to identify a set of shapes corresponding with known suspicious activities. Shape detection model 114 may then generate shape detection metric 116 that identifies suspicious activity 118, based on the set of shapes corresponding with known suspicious market activities. The generation of shape detection metric 116 is discussed further with respect to FIGS. 3A-3C below.

In one or more embodiments, system 100 then identifies a set of analytical models that correspond with the identified shape detection metric. In some embodiments, the set of identified analytical models may correspond with the type of suspicious activity identified by the shape detection metric. In some embodiments, the identified set of analytical models is used to then analyze the market data of the unique financial instrument, to confirm the suspicious activity identified by the shape detection metric. For example, if suspicious activity 118 relates to a certain trading activity, as identified by shape detection metric 116, set of identified analytical models 120 may be models which are able to analyze that type of trading activity and determine if the trading activity was fraudulent or circumstantial. In some embodiments, suspicious activity 118 may include suspicious trading activity, such as, for example, pump and dump activity, insider dealing, trade washing (intent and/or actual), double top, ascending triangle, descending triangle, head and shoulder, inverse head and shoulder, etc.

In some embodiments, the set of identified analytical models is initially disabled, though once identified as corresponding with the identified shape detection metric, is enabled by system 100. In certain embodiments, a suspicious activity alert (e.g., suspicious activity alert 108) is triggered based on confirmation of the suspicious activity identified by the shape detection metric.

In one or more embodiments, if a suspicious activity alert 108 is triggered, as a result of set of enabled analytical models 106 detecting a suspicious activity, or as a result of set of identified analytical models 120 confirming a suspicious activity, an alert is generated, which includes information regarding the suspicious activity. The alert is then sent to a user of system 100. In some embodiments, a user input associated with the suspicious activity alert may be received via a user interface, to system 100.

In some embodiments, system 100 may provide, as input data to shape detection model 114, market data that has been optimized to capture suspicious activity of a unique financial instrument. In one or more embodiments, the optimized market data may be generated using a previously identified shape detection metric, a previous suspicious activity alert, or a combination thereof, of the unique financial instrument. In some embodiments, the optimized market data may be a market data graph comprising market data for the unique financial instrument for a specified time period, which may be different from the predetermined time period initially used to generate the market data graph. In one or more embodiments, the specified time period and predetermined time period may be set by a user of system 100.

For example, a user of system 100 may initially use an intraday time period as the predetermined time period to generate a market data graph 112 to be provided to the shape detection model 114. If a suspicious activity alert is triggered for a transaction on market data graph 112 occurring in a two-hour window, the user of system 100 may then optimize the analysis by using the two hour window as the specified time period to generate an optimized market data graph for the unique financial instrument. Providing this optimized market data graph to shape detection model 114 may allow for better analysis of the transaction, and confirmation of the suspicious activity; providing additional data to the user of system 100 to correct or attempt to remedy the fraudulent market activity.

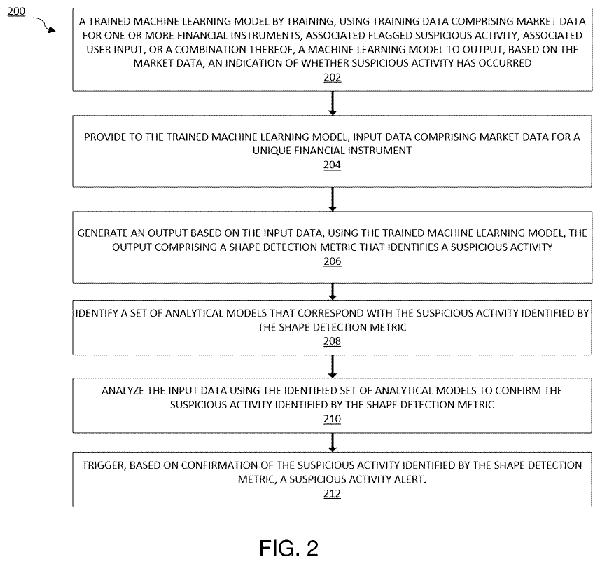

FIG. 2 is an exemplary flowchart 200 for trade surveillance and compliance coverage according to embodiments of the present disclosure. Note that one or more steps, processes, and methods described herein of flowchart 200 may be omitted, performed in a different sequence, or combined as desired or appropriate based on the guidance provided herein. Flowchart 200 of FIG. 2 includes operations for schedule change management, as discussed in reference to FIG. 1. One or more of steps 202-212 of flowchart 200 may be implemented, at least in part, in the form of executable code stored on non-transitory, tangible, machine-readable media that when run by one or more processors may cause the one or more processors to perform one or more of steps 202-212. In some embodiments, flowchart 200 can be performed by one or more computing devices discussed in trade surveillance and compliance coverage system 100 of FIG. 1.

Accordingly, at step 202 of flowchart 200, trade surveillance and compliance coverage system 100 generates a trained machine learning model (e.g., shape detection model 114) by training, using training data comprising a set of market data based on one or more financial instruments, associated flagged suspicious activity, associated user input, or a combination thereof, a machine learning model to output, based on the market data, an indication of whether a suspicious activity alert should be triggered. The training of shape detection model 114 is discussed further in FIG. 5 below.

At step 204 of flowchart 200, trade surveillance and compliance coverage system 100 provides input data comprising market data 104 for unique financial instrument 110 to shape detection model 114. In one or more embodiments, the input data is market data graph 112 including market data 104 for unique financial instrument 110 for a predetermined time period. In some embodiments, the predetermined time period is an intraday time period, for example, a time period during which a stock market is open for trading during a portion of a day, or a time period during the day when a stock market is closed (e.g., between trading sessions, during a temporary automated or manual shut-down of trading, or after the trading close for the day).

At step 206 of flowchart 200, an output is generated based on the input data and using the trained machine learning model, which includes a shape detection metric that identifies a suspicious activity. In some embodiments, shape detection model 114 generates shape detection metric 116 based on market data graph 112 for unique financial instrument 110. In one or more embodiments, shape detection metric 116 identifies suspicious activity 118.

At step 208 of flowchart 200, a set of analytical models that correspond with the suspicious activity identified by the shape detection metric is identified. In one or more embodiments, set of identified analytical models 120 corresponding with suspicious activity 118 as identified by shape detection metric 116 is identified. In some embodiments, set of identified analytical models 120 is enabled once identified at step 208.

At step 210 of flowchart 200, the input data is analyzed using the identified set of analytical models to confirm the suspicious activity identified by the shape detection metric. In some embodiments, market data 104 is analyzed using the enabled set of identified analytical models 120 to confirm suspicious activity 118 identified by shape detection metric 116.

At step 212 of flowchart 200, a suspicious activity alert is triggered based on confirmation of the suspicious activity identified by the shape detection metric. In one or more embodiments, suspicious activity alert 108 is triggered based on confirmation by set of identified analytical models 120 of suspicious activity 118, as identified by shape detection metric 116.

FIG. 3A is an exemplary market data graph 300 (e.g., market data graph 112) for unique financial instrument 110, provided to shape detection model 114 as shown in FIG. 1. As shown on FIG. 3A, shape detection model 114 has identified a set of points (i.e., points 302, 304, 306, and 308) on market data graph 300. In some embodiments, the set of points identified by shape detection model 114 may include local maxima and minima (e.g., points 302 and 304, respectively) as well as upper and lower extrema (e.g., points 306 and 308, respectively). By analyzing transactions in market data graph 300, shape detection model 114 may identify one or more transactions to be analyzed further for suspicious activity.

FIG. 3B is the exemplary market data graph 300 (e.g., market data graph 112) on which shape detection model 114 has identified a transaction 310 to be analyzed further for suspicious activity, based on the identified set of points, including points 302, 304, 306, and 308.

FIG. 3C is an exemplary illustration 312 of transaction 310 as identified on market graph 300 in FIG. 3B. Illustration 312 shows how shape detection model 114 may identify a set of shapes corresponding with known suspicious market activities before and after transaction 310 on market graph 300, based on set of points initially identified by shape detection model 114 (i.e., points 302 and 304), as well as additional points on market data graph 300 (i.e., points 314, 316, and 318).

For example, shape detection model 114 may be trained to recognize that transactions such as transaction 310, where shapes such as those formed by point 304 being lower than points 314, 316, and 302; point 316 being lower than points 314 and 302; and point 318 being lower than points 304, 314, 316, and 302 have occurred, may include “pump and dump” activity, which is illegal market activity. As such, shape detection model 114 may then generate shape detection metric 116 indicating pump and dump or other applicable activity (i.e., suspicious activity 118).

In certain embodiments, shape detection metric 116 may indicate set of shapes corresponding with known suspicious market activities, the suspicious activity (i.e., suspicious activity 118), or a combination thereof. In one or more embodiments, one shape of the set of shapes corresponding with a first known suspicious market activity may also be in another set of shapes corresponding with a second known suspicious market activity. However, the set of shapes corresponding with a known suspicious market activity is unique for each known suspicious market activity. For example, as seen in the examples provided in Table 1 below, an inverse head and shoulder shape may be part of the set of shapes corresponding to two suspicious market activities; painting and pump and dump. The set of shapes corresponding with painting, however, also includes head and shoulders, double bottom, and double top shapes; whereas the set of shapes corresponding with pump and dump activity only includes a rising wedge, in addition to inverse head and shoulders.

TABLE 1
EXAMPLES OF SETS SHAPES CORRESPONDING
WITH KNOWN SUSPICIOUS MARKET ACTIVITIES

| KNOWN SUSPICIOUS | SET OF SHAPES CORRESPONDING WITH |
|---|---|
| MARKET ACTIVITY | KNOWN SUSPICIOUS MARKET ACTIVITY |
| Painting | Inverse Head and Shoulders, Head and |
| | Shoulders, Double Bottom, Double Top |
| Pump and Dump | Rising Wedge, Inverse Head and Shoulders |
| Spoofing | Head and Shoulders, Double Top, Cup |
| | and Handle |
| Wash Trading | Double Bottom, Cup and Handle |

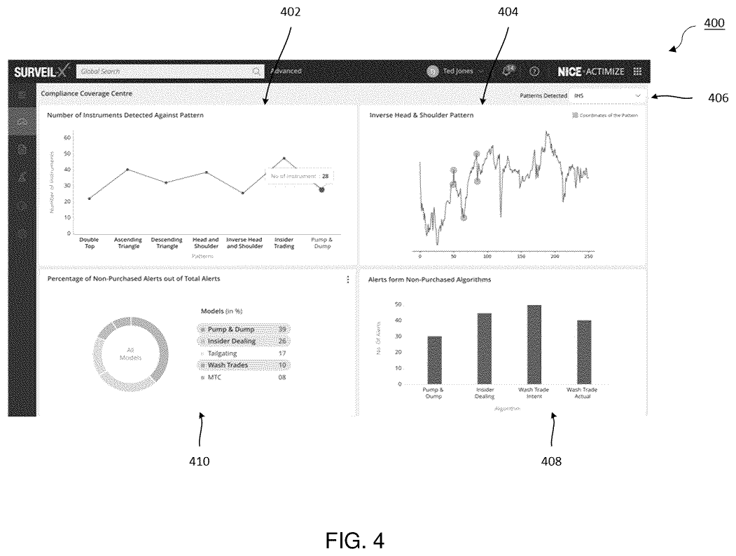

FIG. 4 is an exemplary user interface 400 for receiving suspicious activity alerts, such as suspicious activity alert 108 in FIG. 1, and related information from system 100 for a predetermined time period. In some embodiments, the user of system 100 may select the predetermined time period. Interface 400 may be a view available to users of system 100, such as company auditors, financial departments, executives, etc. In some embodiments, a user of system 100 may use user interface 400 to identify and correct suspicious and/or fraudulent market activity.

Section 402 of interface 400 displays a graph showing a number of unique financial instruments in which a suspicious or fraudulent activity has occurred, or in which a shape corresponding with a known suspicious activity has been identified. For example, as seen in section 402, there are 28 unique financial instruments in which pump and dump activity has occurred, in the time period specified by the user of interface 400.

Section 404 of interface 400 displays a graph showing the market data graph identifying the set of points used to identify the set of shapes corresponding with a detected suspicious activity. Users of interface 400 may select a shape corresponding with a known suspicious activity or a detected suspicious activity to view in section 404 using the drop down menu of detected suspicious activities 406. For example, as seen in section 404, an inverse head and shoulder shape was detected for at least one unique financial instrument.

Section 408 of interface 400 displays a graph showing the count of suspicious activity alerts triggered by analytical models currently disabled by the user (e.g., set of identified analytical models 120). Section 408 allows the user to identify which, if any, currently disabled analytical models may be ideal to enable for auditing subsequent trade compliance. For example, as seen in section 408, a user would be able to identify wash trade intent and insider trading as fraudulent activities occurring in its current market activities based on the output provided by the disclosure herein, and may choose to enable analytical models relating to those fraudulent activities to ensure trade compliance, or more accurate trade compliance and/or more rapidly detected fraudulent activity. In some embodiments, a user with limited budget may choose to only enable analytical models meeting a certain threshold number of suspicious activity alerts triggered.

Section 410 of interface 400 displays the percentages of suspicious activity alerts triggered, in terms of the suspicious activity detected. Further, the display in section 410 indicates whether analytical models related to the detected suspicious activities are currently enabled or disabled. For example, as seen in section 410, analytical models relating to tailgating and MTC activities are currently enabled, with 17% and 8% of suspicious activity alerts triggered for each suspicious activity, respectively. Analytical models relating to pump & dump, insider trading, and wash trades are currently disabled, with 39%, 26%, and 10% of suspicious activity alerts triggered for each suspicious activity, respectively. A user of system 100 may use section 410 of interface 400 to determine whether they have sufficient trade compliance audit coverage, based on the percentage of suspicious activity alerts triggered for activities currently monitored by enabled analytical models.

FIG. 5 illustrates training of a shape detection model (e.g., shape detection model 114 in FIG. 1), according to some embodiments of the present disclosure. Shape detection model 114, when in training mode, receives training data 502 from system 100. In one or more embodiments, training data 502 includes historical transaction data 504. For example, historical transaction data 504 may include market data for one or more financial instruments, associated identified suspicious activity, associated user input in response to the suspicious activity, or a combination thereof. In some embodiments, market data for one or more financial instruments includes data from financial transactions, stock exchanges, financial news providers, historical databases, or a combination thereof. In some embodiments, historical transaction data 504 includes historical transaction data from legitimate transactions as well as from fraudulent transactions.

In one or more embodiments, shape detection model 114 includes a neural network (e.g., neural network 506). Neural networks such as neural network 506 allow shape detection model 114 to learn how to detect suspicious activity from market data, by learning how various shapes corresponding to a set of points on a market data graph may indicate various types of suspicious activity. In some embodiments, neural network 506 may comprise one or more nodes, (e.g., one or more nodes 508) that are each weighted according to what neural network 506 has learned is important in generating the correct output, based on training data 502. For example, shape detection model 114 may modify one or more weights of one or more nodes 508 in neural network 506 as it learns from training data 502 what types of transaction amounts, transaction frequencies, transaction locations, transaction-related user and market behavior, etc. resulted in suspicious, fraudulent, or legitimate activities, and the corresponding set of shapes that can be identified in the market data of those transactions, as seen on a market data graph.

In some embodiments, performance of shape detection model 114 in outputting a shape detection metric (e.g., shape detection metric 116), by accurately detecting suspicious activity based on market data, may be evaluated using metrics such as Mean Absolute Error (MAE), Root Mean Squared Error (RMSE), R-squared, or a combination thereof.

Below are examples of full data structures usable with the present disclosure.
1. Example of Request to fetch market data for the unique financial instrument

Request:
{
“instrument”: ”AMZN”,
“instrumentType”: ”SYMBOL”,
“businessDate”:”20240502”
}

2. Example of Response to fetch market data for the unique financial instrument

```
Response: 200 Ok
{
  “listingId”: 17,
  “businessDate”: 20240126,
  “todayOpen”: 33.91,
  “todayClose”: 34.345,
  “prevClose”: 34.645,
  “adv30”: 3536744.619047619,
  “todayVolume”: 3714972,
  “auctionPrice”: 33.91,
  “auctionQty”: 0.0,
  “prevDayVolume”: 4441999.0,
  “idcSymbol”: null,
  “prevTradeDate”: 0,
  “high”: 34.545,
  “low”: 33.86,
  “vwapPrice”: 34.2826976058,
  “cacheAvail”: false
}
```

3. Example Request to mark disabled analytical models corresponding with detected suspicious activity (e.g., with the shape detection metric)

```
Request:
{
“IdentifiedShape”:”InverseHead&Shoulder”
“ModelsToMark”:[{
    “ModelName”:”Pump&Dump”
    “DataRunDate”:”20240531”
  }]
}
```

### Example Definitions and Context

The disclosure is not limited to these example embodiments and applications or to the manner in which the example embodiments and applications operate or are described herein. Moreover, the figures may show simplified or partial views, and the dimensions of elements in the figures may be exaggerated or otherwise not in proportion.

Where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular.

Where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

As used herein, the term “plurality” can be 2, 3, 4, 5, 6, 7, 8, 9, 10, or more.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or any other suitable combination.

As used herein, a “model” may include one or more algorithms, one or more mathematical techniques, one or more machine learning (ML) algorithms, or a combination thereof.

As used herein, “machine learning” may include the practice of using algorithms to parse data, learn from it, and then make a determination or prediction about something in the world. Machine learning uses algorithms that can learn from data without relying on rules-based programming.

As used herein, an “artificial neural network” or “neural network” may refer to mathematical algorithms or computational models that mimic an interconnected group of artificial neurons that processes information based on a connectionistic approach to computation. Neural networks, which may also be referred to as neural nets, can employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters. In the various embodiments, a reference to a “neural network” may be a reference to one or more neural networks.

A neural network may process information in, for example, two ways; when it is being trained (e.g., using a training dataset) it is in training mode and when it puts what it has learned into practice (e.g., using a test dataset) it is in inference (or prediction) mode. Neural networks may learn through a feedback process (e.g., backpropagation) which allows the network to adjust the weight factors (modifying its behavior) of the individual nodes in the intermediate hidden layers so that the output matches the outputs of the training data. In other words, a neural network may learn by being fed training data (learning examples) and eventually learns how to reach the correct output, even when it is presented with a new range or set of inputs.

A neural network may process information in two ways; when it is being trained it is in training mode and when it puts what it has learned into practice it is in inference (or prediction) mode. Neural networks learn through a feedback process (e.g., backpropagation) which allows the network to adjust the weight factors (modifying its behavior) of the individual nodes in the intermediate hidden layers so that the output matches the outputs of the training data. In other words, a neural network learns by being fed training data (learning examples) and eventually learns how to reach the correct output, even when it is presented with a new range or set of inputs. A neural network may include, for example, without limitation, at least one of a Feedforward Neural Network (FNN), a Recurrent Neural Network (RNN), a Modular Neural Network (MNN), a Convolutional Neural Network (CNN), a Graph Convolutional Network (GCN), a Residual Neural Network (ResNet), an Ordinary Differential Equations Neural Networks (neural-ODE), or another type of neural network.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

1. A trade surveillance and compliance coverage system comprising:
a trade surveillance and compliance coverage computer system comprising at least one processor and a non-transitory computer readable medium operably coupled thereto, the non-transitory computer readable medium comprising a plurality of instructions stored in association therewith that are accessible to, and executable by, the at least one processor, to perform operations which comprise:
disabling a plurality of analytical models to save resources;
generating a trained shape detection machine learning model by training, using training data comprising market data for one or more financial instruments, associated flagged suspicious activity, associated user input, or a combination thereof, a machine learning model to output, based on the market data, an indication of whether suspicious activity has occurred, wherein training the shape detection machine learning model comprises modifying one or more weights of one or more nodes of an artificial neural network;
providing, to the trained shape detection machine learning model, input data comprising market data for a financial instrument traded in a transaction,
wherein the input data is a market data graph comprising market data for the traded financial instrument for a predetermined time period;
generating an output based on the input data, using the trained machine learning model, the output comprising a shape detection metric that identifies a particular suspicious trading activity;
identifying a set of the disabled analytical models that correspond with the particular suspicious trading activity identified by the shape detection metric,
wherein the set of disabled analytical models is automatically enabled once identified;
analyzing the input data using the enabled set of analytical models to confirm the particular suspicious trading activity identified by the shape detection metric;
triggering, based on confirmation of the particular suspicious trading activity identified by the shape detection metric, a suspicious activity alert; and
correcting the particular suspicious trading activity.

2. The system of claim 1, wherein market data for the one or more financial instruments comprises data from: financial transactions involving the one or more financial instruments, stock exchanges, financial news providers, historical databases, or a combination thereof.

3. The system of claim 1, wherein generating an output based on the input data, using the trained machine learning model, the output comprising a shape detection metric that identifies a suspicious activity, comprises:
identifying a set of points on the market data graph, comprising lower and upper extrema;
identifying, based on the set of points on the market data graph, a set of shapes corresponding with known suspicious market activities; and
generating, based on the set of shapes corresponding with known suspicious market activities, a shape detection metric that identifies a suspicious activity.

4. The system of claim 1, wherein triggering the suspicious activity alert comprises:
generating an alert comprising the identified suspicious activity; and
with a user interface, sending the alert to a user of the system.

5. The system of claim 1, wherein the operations further comprise running the input data through a set of enabled analytical models.

6. The system of claim 1, wherein the operations further comprise receiving, via a user interface, user input associated with the suspicious activity alert.

7. The system of claim 1,
wherein the input data provided to the trained shape detection machine learning model has been optimized to capture suspicious activity,
wherein the optimized input data is generated using a previously identified shape detection metric, a previous suspicious activity alert, or a combination thereof, of the traded financial instrument; and
wherein the optimized input data is an optimized market data graph comprising market data for the unique financial instrument for a specified time period.

8. A method of surveilling trades and providing compliance coverage, comprising, with a trade surveillance and compliance coverage computer system comprising at least one processor and a non-transitory computer readable medium operably coupled thereto:
disabling a plurality of analytical models to save resources;
generating a trained shape detection machine learning model by training, using training data comprising market data for one or more financial instruments, associated flagged suspicious activity, associated user input, or a combination thereof, a machine learning model to output, based on the market data, an indication of whether suspicious activity has occurred, wherein training the shape detection machine learning model comprises modifying one or more weights of one or more nodes of an artificial neural network;
providing, to the trained shape detection machine learning model, input data comprising market data for a financial instrument traded in a transaction,
wherein the input data is a market data graph comprising market data for the traded financial instrument for a predetermined time period;
generating an output based on the input data, using the trained machine learning model, the output comprising a shape detection metric that identifies a particular suspicious trading activity;
identifying a set of the disabled analytical models that correspond with the particular suspicious trading activity identified by the shape detection metric,
wherein the set of disabled analytical models is automatically enabled once identified;
analyzing the input data using the enabled set of analytical models to confirm the particular suspicious trading activity identified by the shape detection metric;
triggering, based on confirmation of the particular suspicious trading activity identified by the shape detection metric, a suspicious activity alert; and
correcting the particular suspicious trading activity.

9. The method of claim 8, wherein market data for the one or more financial instruments comprises data from: financial transactions involving the one or more financial instruments, stock exchanges, financial news providers, historical databases, or a combination thereof.

10. The method of claim 8, wherein generating an output based on the input data, using the trained machine learning model, the output comprising a shape detection metric that identifies a suspicious activity, comprises:
identifying a set of points on the market data graph, comprising lower and upper extrema;
identifying, based on the set of points on the market data graph, a set of shapes corresponding with known suspicious market activities; and
generating, based on the set of shapes corresponding with known suspicious market activities, a shape detection metric that identifies a suspicious activity.

11. The method of claim 8, wherein triggering the suspicious activity alert comprises:
generating an alert comprising the identified particular suspicious trading activity; and
with a user interface, sending the alert to a user of the system.

12. The method of claim 8, further comprising running the input data through a set of enabled analytical models.

13. The method of claim 8, further comprising receiving, via a user interface, user input associated with the suspicious activity alert.

14. The method of claim 8,
wherein the input data provided to the trained machine learning model has been optimized to capture suspicious activity,
wherein the optimized input data is generated using a previously identified shape detection metric, a previous suspicious activity alert, or a combination thereof, of the unique financial instrument; and
wherein the optimized input data is an optimized market data graph comprising market data for the traded financial instrument for a specified time period.

15. A non-transitory computer-readable medium having stored thereon computer-readable instructions executable by at least one processor to perform operations which comprise:
disabling a plurality of analytical models to save resources;
generating a trained shape detection machine learning model by training, using training data comprising market data for one or more financial instruments, associated flagged suspicious activity, associated user input, or a combination thereof, a machine learning model to output, based on the market data, an indication of whether suspicious activity has occurred, wherein training the shape detection machine learning model comprises modifying one or more weights of one or more nodes of an artificial neural network;
providing, to the trained shape detection machine learning model, input data comprising market data for a financial instrument traded in a transaction,
wherein the input data is a market data graph comprising market data for the traded financial instrument for a predetermined time period;
generating an output based on the input data, using the trained machine learning model, the output comprising a shape detection metric that identifies a particular suspicious trading activity;
identifying a set of the disabled analytical models that correspond with the particular suspicious trading activity identified by the shape detection metric,
wherein the set of disabled analytical models is automatically enabled once identified;
analyzing the input data using the enabled set of analytical models to confirm the particular suspicious trading activity identified by the shape detection metric;
triggering, based on confirmation of the particular suspicious trading activity identified by the shape detection metric, a suspicious activity alert; and
correcting the particular suspicious trading activity.

16. The non-transitory computer-readable medium of claim 15, wherein market data for the one or more financial instruments comprises data from: financial transactions involving the one or more financial instruments, stock exchanges, financial news providers, historical databases, or a combination thereof.

17. The non-transitory computer-readable medium of claim 15, wherein generating an output based on the input data, using the trained machine learning model, the output comprising a shape detection metric that identifies a suspicious activity, comprises:
identifying a set of points on the market data graph, comprising lower and upper extrema;
identifying, based on the set of points on the market data graph, a set of shapes corresponding with known suspicious market activities; and
generating, based on the set of shapes corresponding with known suspicious market activities, a shape detection metric that identifies a suspicious activity.

18. The non-transitory computer-readable medium of claim 15, wherein triggering the suspicious activity alert comprises:
generating an alert comprising the identified suspicious activity; and
with a user interface, sending the alert to a user of the system.

19. The non-transitory computer-readable medium of claim 15, further comprising receiving, via a user interface, user input associated with the suspicious activity alert.

20. The non-transitory computer-readable medium of claim 15,
wherein the input data provided to the trained machine learning model has been optimized to capture suspicious activity,
wherein the optimized input data is generated using a previously identified shape detection metric, a previous suspicious activity alert, or a combination thereof, of the unique financial instrument; and
wherein the optimized input data is an optimized market data graph comprising market data for the traded financial instrument for a specified time period.
